(19) United States
(12) Patent Application Publication
(10) Pub. No.: US 2010/0043141 A1
(43) Pub. Date: Feb. 25, 2010

(54) Device enabling the application of mechanical force to flexible sheet material

(76) Inventors: Kenneth Short, Lutz, FL (US); Manon Short, Lutz, FL (US)

Correspondence Address: Kenneth Short, 3404 Burlington Woods Ct, Lutz, FL, 33559, US

(21) Appl. No.: 12/196,571

(22) Filed: Aug. 22, 2008

(51) Int. Cl. A61G 7/10; A61G 7/00; A61G 7/14

(52) U.S. Cl. 5/89.1

(57) ABSTRACT

Apparatus to assist in the application of mechanical lifting force to a sheet. For instance, healthcare workers often roll patients, who require this type of assistance, from side to side in an effort to clean the patient, change the bed sheets on the patient's bed, or to prevent bedsore development on the patient. This particular apparatus allows for the mechanical rolling of patients using a more effective, and less costly mechanical solution than has been previously available. Less manual effort is required to roll a patient using this device, and nothing has to be placed under the patient to allow for the use of this device in rolling a patient. This device can be securely and safely attached directly to the bed sheet, which is unique in the field of patient rolling solutions. This device can also be used to boost a patient up in bed, if this device is applied to both sides of the patient while the patient is in bed. This device can also be attached to any other sheet material, thus allowing for the use of mechanical lifts in any situation where the application of a lifting force must be applied to a flexible sheet material.

### BACKGROUND OF THE INVENTION

1. Field of Invention

The invention relates to the need for healthcare workers to roll a patient from a position where the patient is lying flat on their back, into a position where the patient is either lying on the patients' left side of their body, or on the patients' right side of their body. It can also be used to provide a lifting force to both sides of the patient, thus allowing for their “boosting up” while remaining in bed. The invention also relates to any other situations wherein an individual, or individuals, must use a mechanical lifting device, and they must apply this mechanical force to flexible sheet material.

2. Description of Related Technology

Healthcare workers are regularly responsible for the care of patients involving the movement of patients. Some of the patients are not able to move themselves from their position on their bed, for a multitude of reasons. Patients need to have their sheets changed regularly so that the healthcare setting can be relatively sanitary and free from infectious and otherwise unclean conditions. All areas of a patient's body must be cleaned regularly to avoid infections from developing, and to otherwise maintain sanitary conditions for the patient. Patients can also readily develop what are commonly referred to as bedsores if they are not moved about frequently enough. Many other types of work may require the use of a similar technique where a mechanical lift is available, and the material to be lifted is currently on top of a flexible sheet.

Given the basic needs of a patient, the healthcare worker must put himself at risk of injury by manually manipulating the position of the patient. As many patients are not able to assist with this movement, it becomes incumbent upon the healthcare worker to manually, physically move the patient about the bed. This manual and very physical activity is one of the leading causes of injury amongst healthcare workers. With very heavy patients, it is possible for more than one person to become injured while caring for only one patient. In other types of work, the manual manipulation and movement of the material that is lying on the sheet can be avoided, as well as the associated injuries, by using this device to move the material.

Additionally, the healthcare worker will often use their hands to push and prod the patient into position, which can result in bruising on the patient, as the amount of pressure per square inch being applied to the patient can be very high. So not only can the healthcare worker become injured, but the patient can experience injuries as well.

The process of moving patients about the bed can be troublesome, dangerous, and very unpleasant for the healthcare worker, making the situation favorable for the development of bedsores as it is only natural that the healthcare worker might avoid moving the patient about, given the level of difficulty, and risk of injury, involved in the task. Along the same lines, the movement of any material can be difficult, and can lead to injuries. The use of this device in the movement of any material, in any setting, where the material to be moved is currently resting on a sheet, can help individuals avoid injuries.

There have been many products developed to aid the healthcare worker in the movement of patients from one bed to another, from a position in bed to a position out of bed, to laterally move a patient in the same bed, whether it be toward the head of the bed, toward the foot of the bed, or toward either side of the bed, and a plurality of other situations, but there has not yet been a similar, low cost, tool devised to work with existing mechanized equipment that will mechanically roll the patient from side to side without the use of a sling, or that can “boost” a patient up in bed without the use of a sling. The use of a sling necessitates manually rolling the patient in order to place the sling the under patient. This device does not require that a sling be used as it allows the mechanical force to be applied directly to the bed sheet, in the case of a hospital patient, or to any other sheet material when used in other settings.

Many products offered to the healthcare industry have been developed to assist with the movement of patients, and briefly described in [008], but there are none that fulfill a very specific purpose which is fulfilled by this particular assembly. This apparatus will work with most existing “lifting equipment” so that the cost to add this functionality to the existing equipment will be minimal. In other areas of industry, outside healthcare, there are many applications that can take advantage of this technology also.

U.S. Pat. No. 6,615,423 (Sverdlik) indicates that this mechanism can be used to roll a patient, but this is only accomplished by acquiring the specialized equipment as outlined in that patent. Using this patent, a healthcare establishment cannot leverage the investment they have already made in mechanized devices that are more mobile, and can be moved from room to room. Also, the C shaped gripper described contains multiple, separate parts which will become useless when any one of the parts becomes misplaced.

U.S. Pat. No. 2,665,432 (Butler) describes a cart with a manual crank connected to a pull unit and a transfer sheet. This would be useless in rolling patients as it is only designed to pull a patient laterally, and the patient would have to be rotated back and forth to allow the transfer sheet to be placed under the patient in the first place.

U.S. Pat. No. 2,733,452 (Tanney) uses a metal reinforced transfer sheet. Again, the patient would have to be placed upon this specialized transfer sheet in order for this to be a useful idea.

U.S. Pat. No. 4,747,170 (Krouse) is a device that can only accomplish a lateral transfer of a patient.

U.S. Pat. No. 5,737,781 (Votel) and U.S. Pat. No. 5,890,238 (Votel) only provide for the lateral transfer of a patient.

U.S. Pat. No. 557,456 (Utter) discloses a clamp for holding bed sheets firmly in place. Utter does not suggest that the clamp can be used in any other fashion than to attach the clamp to an object other than the bed. Additionally, the design of Utter would allow for the clamp to fail under the heavy loads that will be experienced when this device is put to use in many diverse settings.

U.S. Pat. No. 2,050,189 (LePage) discloses a fastening device for use as a garment supporter. The fastening device includes two members, a male member and a female member. The mail member has a long shank with an upper end attached to a supported strap. The mail member also includes a head which passes through an interlocking opening in the female member. The opening is of such size to permit the head of the male member to pass through along with a portion of a fabric garment. LePage, in a similar fashion to Utter, utilized a device which retains the fabric in place by attaching the fabric to the strap which is not attached to another object. LePage does not teach or suggest utilizing a fastening device which is secured to another object. A final flaw in this design is the rather sharp edges which will tear flexible sheet material sheet if brought under a heavy load.

U.S. Pat. No. 4,660,240 (Hutton) discloses a bed sheet attachment device for use in combination with a waterbed having a fluid-filled mattress. The device includes a two part fastener for gripping the sheets of a waterbed. The fastener is connected by an elastic strap to the interior of a bed frame surrounding the mattress. The fastener includes a plate defining a slot having a larger portion for receiving a stud having a neck on one end tapering to a narrow portion on the other end. The plate is placed beneath the sheet and the stud is pushed down through the enlarged portion of the slot from above the sheet, with the sheet being forced into the slot. The stud is then slid into the narrow portion of the slot to grip the sheet. However, Hutton does not teach or suggest an attachment device which secures the fabric in place without securing the attachment device to the bed.

U.S. Pat. No. 5,117,537 (Hunter) discloses a clip device removable secured to a portion of a sheet of flexible material. The clip device includes a sheet-engaging portion having an integral tongue which projects forwardly from the device's rear portion and which can be deflected from the general plane of the device. The sheet-engaging portion also includes a peripheral frame member which extends forwardly from the rear portion of the device, and a front end with an inner edge that lies adjacent the front end of the undeflected tongue. The device has an open position in which the tongue is downwardly deflected away from the first side of the frame to provide a gap for insertion of the portion of the sheet of flexible material. The device also has a locked configuration in which the tongue is manipulated through the frame member to the tongue lies in close proximity to the frame front end. The front edge of the tongue and the frame. The design of this device does not allow for a significant amount of the flexible material to be bunched up and inserted into the front of the device. During the process of moving a patient, a healthcare worker will rarely attach only the edge of the sheet to the sheet attachment device, precluding the use of the device devised by Hunter. In applications outside the healthcare setting, there will often be instances where a considerable amount of sheet material will be bunched up, again, precluding the use of the Hunter device.

U.S. Pat. No. 6,044,526 (Putney) discloses an apparatus having a clasp which can be wrapped around a portion of fabric, and inserted into a circular frame with a portion of fabric, allowing the fabric to be held by this device without a hole having to be made in the fabric, and without being attached to another object. Putney does not teach or suggest that this device could be used in conjunction with mechanical apparatus allowing this device to be used as part of a load bearing system. The design also does not account for the heavy weights encountered in the many diverse settings in which this device will be used.

Review of each of the foregoing references reveals no disclosure or suggestion of an apparatus as that described herein. Thus, it would be a distinct advantage to have an apparatus which holds fabric in a desired position without making a hole in the fabric, and able to sustain heavy loads without a likelihood of tearing the sheet to which it is attached. In addition, the apparatus must be able to be attached to a mechanical lifting device, as commonly used in healthcare and other settings, and be adaptable to fit the many models of lifting equipment that are popularly used. Outside the healthcare setting, the device can be used on any lifting equipment already in use, and will not encourage the tearing of the sheet. The capacities of the device are only limited by the specific material selected to implement the invention, and the capacities can therefore be changed to fit the application at hand, simply by the use of higher strength, or lesser strength, components.

### SUMMARY OF THE INVENTION

The first aspect is a method of attaching a strap to a sheet in a way that allows for multiple attachment points to be used at the same time, and also allows for an attachment that will not give way, or initiate a tear in the sheets. This aspect of the invention will be created out of formed metal with every edge rounded and/or circular in nature, tested to ensure high strength. It will be an oblong object, similar in shape to the number 8. The top of the object will be flattened so that it will more readily hold a strap in place, without having the tendency to have the width of the strap collect in the middle of this flattened section. In the middle section of the 8, where we find the cross being made, the cross will be separated, and the left and right sides remain intact so that there is an undisturbed area from one end of the 8 to the other end of the eight, and this space is narrower in the middle than at either end, but nearest the aforementioned flat end, there will be the widest space. Attached to this object by a high tensile strength cable will be a hard rubber ball made of material, like the object itself, the cable, and all other attached pieces, of a material that is not affected in a negative way by the consistent application of any cleaners, fluids, or other chemicals that may be found in the environment in which the device will be used. The ball shall have a diameter that is not too great so that it can pass freely through the wider end of the object, but is great enough so that it cannot pass through, freely or otherwise, through the more narrow end of the object. When a portion of the sheet material is wrapped around the ball, then the ball and the portion of the sheet in which the ball is wrapped, are both passed through the wider end of the object, then pushed down into the more narrow end of the object, the ball will not allow the sheet to be removed from the object under all pressures, and will not have a tendency to tear the sheet as all surfaces are round and smooth. There shall be more than one of these assemblies attached to a sheet at the same time, allowing for a more even distribution of the lifting load, by straps or cables of any material, that are not affected by the chemical agents used in the various work settings.

The second aspect of the invention is the method by which the first aspect will be attached to the variety of mechanical lifting devices used in the many lifting situations. The high tensile strength strap, or cable, which is attached to the first aspect of the invention, will extend from the first aspect for an appropriate length. The length of strap or cable will end in a simple loop so that the loop can be placed onto the lifting hooks that are employed by the mechanical lifting devices of nearly all manufacturers.

The merger of aspect one of the invention, including the metal device shaped similar to the number eight, the high strength cable that connects this metal piece to the rubber ball, the rubber ball, and aspect two of the invention, which is the high tensile strength strap or cable, form an assembly.

The third aspect of this invention is the use of one or more assemblies as a single implementation of the invention. In most lifting situations, more than one attachment point will be indicated, and the use of multiple assemblies that may be attached to each other by sewing the straps together, and/or by using a lanyard to keep multiple assemblies attached, will be advantageous.

### DESCRIPTION OF THE DRAWINGS

The invention will be described as if it were to be used in the healthcare setting, and the invention is being used to roll a patient while the patient remains in bed. The application of the invention to other lifting situations, including the boosting of a patient in bed, can be easily imagined based upon the following description of the invention in use. The invention will be described with reference to the following detailed drawings and descriptions of each aspect of the invention, wherein like reference numerals are used to represent like aspects, and in which:

FIG. 1 is a side view of the invention being used to roll a patient. Please note that this drawing is not drawn to scale, and does not purport to represent the final dimensions or scale to be used in the final, marketable product.

FIG. 2 is the same side view, but with only one assembly being shown. One assembly consists of the merger of the first and second aspects of the invention as described in [0023] above. Please note that this drawing is not drawn to scale, and does not purport to represent the final dimensions or scale to be used in the final, marketable product.

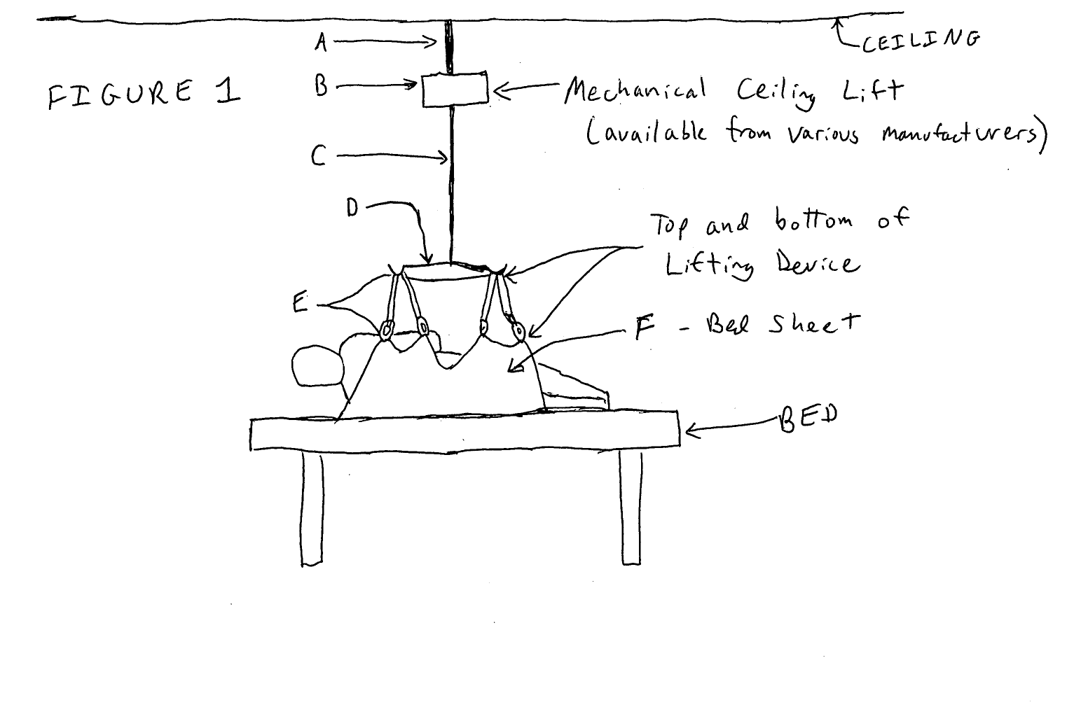

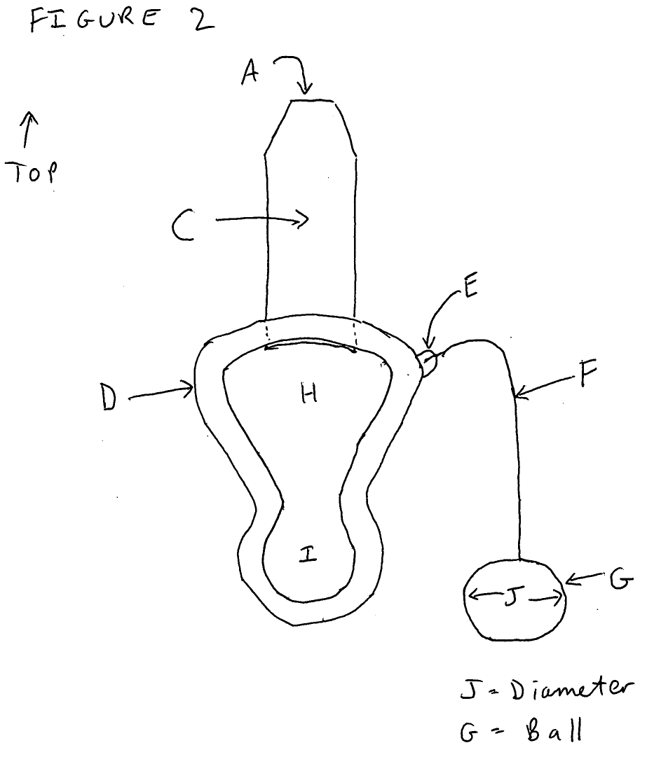

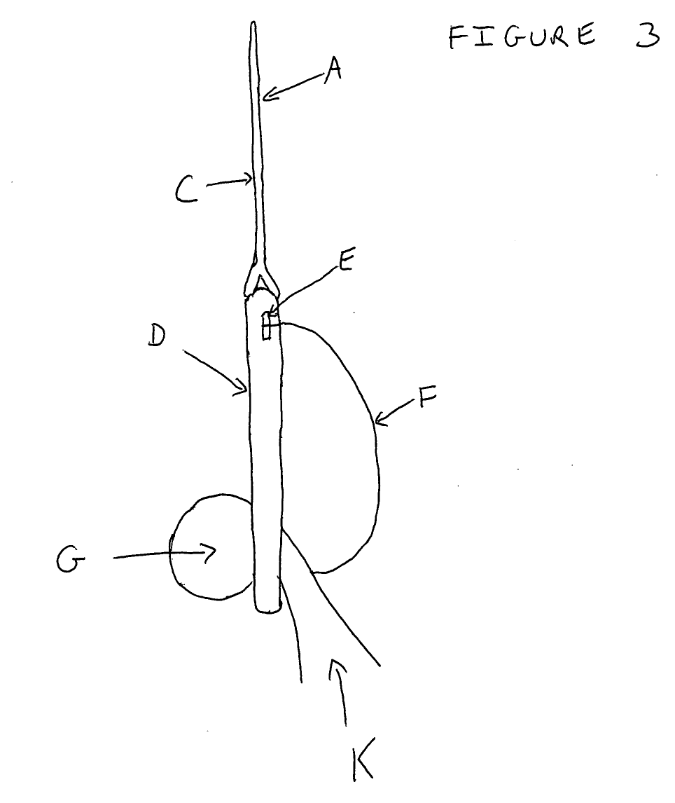

In FIG. 1, we see a side view of a patient being rolled while still lying in bed. There is a ceiling lift in this particular room, but the invention is able to work with any type of lifting equipment, including ceiling lifts, and Hoyer lifts, and it is able to work with the lifting equipment from most manufacturers that uses the normal hooks as the attachment mechanism to their device. In FIG. 1, the ceiling lift is composed of the parts labeled A) which is the method by which this ceiling lift is securely fastened to the ceiling of the room (attachment methods vary, but have no bearing on the usefulness of this invention), B) which is the mechanical lifting motor, which by using electrical power will allow more of the cable C to be extended, and which can also retract C, and C), which is the lifting cable that is coiled up inside of B, but that can be extended from B so that the lifting hooks, carry bar, or hanger bar (D) can be lowered closer to the patient, and D) the lifting hooks, carry bar, or hanger bar, which are attached to C, and are also attached to the lifting device we are herein describing.

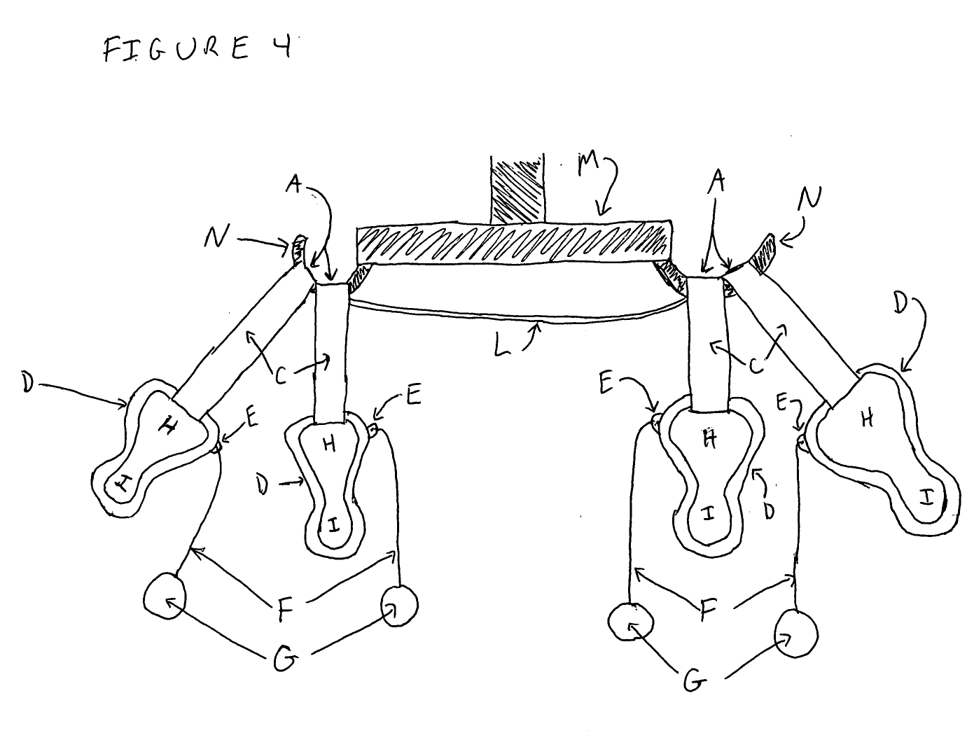

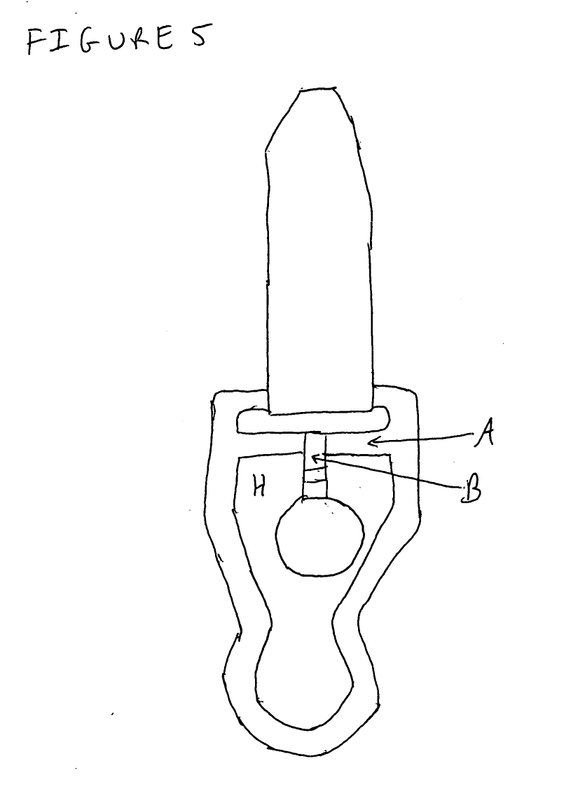

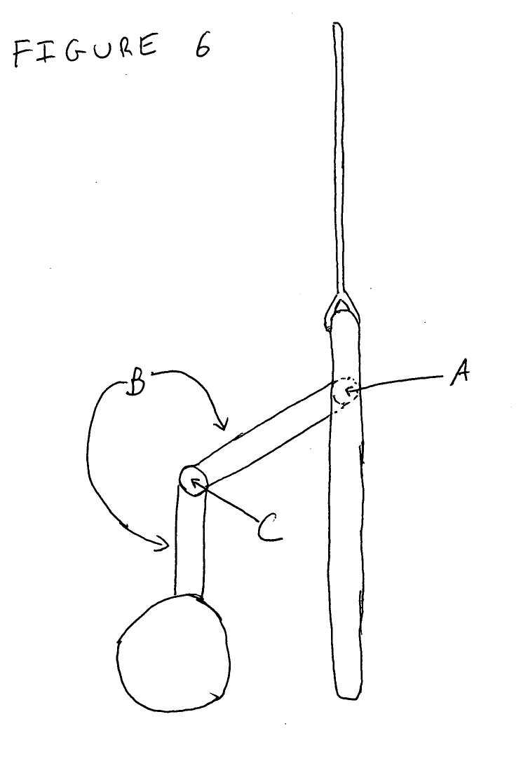

Still referring to FIG. 1, the healthcare worker would have lowered the ceiling lift hooks (D) so that it was easily within reach. The healthcare worker would have slipped the looped end of the two high strength lifting straps over the respective hooks (D) which are part of the ceiling lift. Without yet raising the lifting hooks built into the ceiling lift, the healthcare worker would have grasped the edge of the bed sheet in an appropriate spot, then would have wrapped a small portion of the bed sheet around the securing ball, and pushed the ball, with the portion of sheet still wrapped around it, through the area H of item D, as seen in FIG. 2. In FIG. 1, our invention is represented as item E, but this drawing of the invention is not as detailed as FIG. 2.

Now referring to FIG. 2, the use of the device is employed through the following steps. The worker would maneuver the hard rubber ball, item G, of diameter J, with a portion of the sheet wrapped around it, through area H of item D. Area H is large enough such that a circular object of diameter J, with a portion of sheet wrapped around it, will still pass freely through it.

Still referring to FIG. 2, now that the ball, with the portion of the sheet wrapped around it, has passed through area H, the worker will then move the ball, with the sheet still wrapped around it, down to area I of FIG. 2. The ball, being of diameter J, has a greater diameter than the circular section of area I, FIG. 2. Because the ball has a greater diameter than this more narrow section, it is clear that the ball, with the addition of the portion of sheet wrapped around it, will remain with a greater diameter than diameter. I. This being the case, it will be impossible for the sheet, wrapped around the ball, to be pulled through area I, and out of item D. The fact that the sheet will not be able to be pulled out, unless the worker moves the ball, with the portion of sheet wrapped around it, back to the wider section of item D, area H of item D, will allow the worker to secure the sheet in this way.

Now referring to FIG. 1, after the worker has wrapped a portion of the sheet around the securing ball, pushed the wrapped ball through the wider section displayed as FIG. 2, item D, area H, and then moved the wrapped ball to the more narrow portion displayed as FIG. 2, item D, area I, the worker would have repeated this same process for the other connection points on the sheet.

Referring to FIG. 1; after connecting the lift to the desired spots on the sheet the worker would then engage the mechanical lifting equipment, in this example the equipment being used is a ceiling lift, to apply upward pressure on the lifting apparatus. Because our invention connects the lifting apparatus to the bed sheet, the bed sheet would first be pulled tight, and then continue by rolling the patient, in this case.

The portion of FIG. 2 labeled A is at the top of this figure, and this is the portion of the lifting strap that is formed into a loop so that they can easily be placed over the lifting hooks which are employed on the equipment used in patient handling. These hooks are made to receive the looped end of high strength lifting straps, which is one aspect of our invention.

The majority of the lifting strap is represented by the portion labeled C on FIG. 2.

FIG. 2, item D is the sheet gripper. The portion of D, closest to the top of FIG. 2 will be attached to a high strength strap. The attachment will be made by the sewing of the strap onto itself, after it has been looped through item D, and folded back upon itself.

FIG. 2, item E is a metal tab, which is firmly attached to item D. This tab will have a small hole drilled through it so that it can receive the lanyard labeled F. Alternatively, a hole may be drilled into item D, so that the cable, item F, can be directly fastened to item D through the use of glue, or a welding process. In this case, the tab, Item E, may not be needed or attached to Item D.

FIG. 2, item F is the lanyard which will be attached to the metal tab E on one end, and to the hard rubber ball G on the other end.

FIG. 2, item G is a hard rubber ball. This ball will be made of a durable synthetic material that can withstand the various chemical disinfectants commonly used in the healthcare setting. When this device is being used, the ball, G, will be wrapped in a small portion of the sheet, and pushed through area H.

FIG. 2, area H is the widest section of item D. It will be wide enough such that the ball, item G, with a small portion of sheet wrapped around it, will easily slip through.

FIG. 2, area I is the much more narrow section of item D. At the very top of area I, the gap between the two sides of item D will be less than the gap at the widest section of area I, if being measured horizontally on FIG. 2. The fact that the gap at the “entry” of area I is smaller than the gap in the wider, circular portion of area I is a key to the ability of our invention to hold the sheet without any allowance for the sheet to slip out. It should be noted that the diameter, J, of ball G, is greater than the widest section of area I, if being measured horizontally on FIG. 2. When the healthcare worker moves the ball, G, with a portion of the bed sheet wrapped around it through FIG. 2, area H, and moves the ball, still with the bed sheet wrapped around it, down through item D, and into area I, the healthcare worker will then have very easily attached the bed sheet to the mechanical patient lifting equipment in such a way as to allow himself to easily and safely employ the use of the mechanical lifting equipment with no risk of the bed sheet becoming dislodged, and possibly dropping the patient.

FIG. 3 is a side view of the invention, with a portion of a bed sheet engaged, and being firmly gripped by the invention. I will use the same item labels on this figure as I used to describe FIG. 2, so that the diagram will be more understandable. On FIG. 3, item A, is the uppermost portion of the lifting strap, which form a loop, allowing it to be used with the majority of lifting equipment on the market today.

FIG. 3, item C, is the majority of the lifting strap, which will connect to the lifting equipment at the top, and the portion of the invention that attaches to a bed sheet, at the bottom.

FIG. 3, item D, is the sheet gripper, from a side view. Item E, is the tab to which item F connects. Item F is the lanyard which will be attached to the tab, item E, on one end, and to the hard rubber ball, item G, on the other end.

FIG. 3, Item G is a hard rubber ball. In FIG. 3, item G is wrapped up in a portion of the bed sheet, so we cannot directly see item G in this view, but its shape is clear as the bed sheet is wrapped around it, and then pulled tight as the patient is lifted by engaging the mechanical lifting equipment.

FIG. 3, area H and area I, which are the interior portions of item D, are not visible from this side view. FIG. 3, Item K, is the bed sheet, which was not drawn in FIG. 2, but was labeled as item F in FIG. 1.

FIG. 4 is the overall view of the invention. It is a combination of four assemblies, as diagramed in FIG. 2. Four sets of the assemblies, used in tandem at the same time, will provide the worker the ability to connect to the sheets at four different points, which will spread the weight of the load across four connection points. This will serve two purposes: 1) to lessen the risk of a sheet tearing as would be more likely with fewer connection points, and 2) to lessen the risk of a load becoming unstable during the lift, as might happen if the worker had not properly connected the invention to the sheet and the use of only two connection points were the goal. (if one connection point fails, but there are four in use, leaving three connection points, the stability of the load will be less affected than if one connection point were to fail, and only two were in use, leaving only one connection point)

In FIG. 4, the labels of each part of the invention match the labels assigned in FIG. 2, namely: A is the loop section at the uppermost part of the lifting strap, C is the majority of the lifting strap that extends from A down to item D. Item D is the sheet gripper, and item E is a tab firmly attached to item D, which will hold one end of the lanyard, item F. Item F is a lanyard that attaches on one end to item D, and on the other end to the hard rubber ball, item G. The areas labeled H and I are interior portions of the sheet gripper, item D. Area H is where the ball, with a portion of a bed sheet wrapped around it will be inserted, and then the ball and sheet will be moved down into area I, thereby securing the sheet to the sheet gripper, item D.

The following items have not previously been described in any of the drawings, except that in FIG. 1, item D is the hangar bar, which is part of the mechanical lifting equipment. In FIG. 4, the hanger bar is labeled item M, and attached to item M are two instances of item N. Item N are hooks which are attached to the hangar bar, which is part of the mechanical lifting equipment. Item A, which is the looped end of the lifting strap, is looped over the hanger bar hooks, item N, thus allowing the mechanical lifting force of the lifting equipment, to be applied through the invention and delivered to the bed sheet. Item L is a lanyard that serves the purpose of connecting the two sides together, so the invention remains whole, and no part of the invention is misplaced.

The materials used to create this device may vary to a degree, but it may be created in the following way. In FIG. 4, items A, C, and L may be made out of a synthetic material, such as polypropylene, so that these components are strong and will resist harsh chemicals and abrasion. In FIG. 4, items D and E may be made out of medical grade stainless steel by a capable machine shop. Item F may be made of multi strand stainless steel cable, and item G may be made of a hard, yet grippy rubber material.

In another embodiment of the invention, FIG. 5, area H may be made a bit longer, with a cross member running across it. This cross member, labeled item A, would be used as a connection point for the swing arm, item B. The swing arm could hold the hard rubber ball. In this embodiment, the tab, or connection point to the ball lanyard would be eliminated. The lanyard holding the ball would be eliminated in this embodiment. A side view of this embodiment is FIG. 6. Here, the cross member, item A, in FIG. 5, is not visible. FIG. 6, item B is the swing arm, and Item C is a hinge in the swing arm, which provides the movement necessary to allow the ball to be moved through the interior of the invention, and down into the more narrow portion of the sheet gripper, which is the location the ball needs to be in so that the gripping of the sheet is accomplished.

The invention has been described in terms of more than one embodiment. The description of these embodiments should in no way be considered limiting of the broad scope of the invention set forth in the preceding document.

I claim:

1. A patient handling assembly, using existing lifting equipment as the source of lifting power, used to apply mechanical lifting force to any sheet like material, including bed sheets, the patient handling assembly comprising: a strap, or a cable, or a rope or any other flexible and strong material, which can be used to attach to almost all patient handling equipment on one end, and on the other end, attached to a sheet gripper; the sheet gripper comprised of a metal, steel, or other sufficiently strong material, and a ball made of rubber, plastic, or any other material that allows the ball to fulfill its function, which is to become wrapped in the sheet material, and positioned relative to the metal portion of the sheet gripper such that the ball, wrapped in the sheet cannot pass through the metal portion of the sheet gripper as mechanical force is applied to the patient handling assembly, and a lanyard to hold the ball; the lanyard comprised of a string, or a rope, or a cable, or a metal arm, or any other material that will hold the ball so that it remains part of the patient handling assembly.

2. The patient handling assembly of claim 1, further comprising of multiple patient handling assembles as described in claim 1 into one unit as described in the drawings submitted with this patent application.

3. The patient handling assembly of claim 1, integrated into the carry bar of a manufacturers patient lifting or patient handling equipment such that the patient handling assembly of claim 1 can be used when needed and folded, or otherwise retracted, up and out of the way when a different device is to be attached to the mechanical patient lifting or patient handling equipment.

4. The patient handling assembly of claim 1, wherein the gripper can be removed from the remainder of the assembly.

5. The patient handling assembly of claim 1, wherein the strap, cable, rope, or other flexible and strong material is attached, on one end, to the lifting equipment which is the source of the mechanical lifting power, in such a way that it cannot be removed easily by the caregiver, or in other words, it is attached to the lifting equipment and cannot be moved from one piece of equipment to another without the use of some tools other than the caregivers hands.

6. The patient handling assembly of claim 1, wherein the shape of the gripper and the ball are modified such that the portion of the gripper comprised of the ball is no longer in the shape of a ball, but is some other shape that achieves the same purpose that the ball achieves in the design being claimed herein, namely, it prevents the sheet from passing through the metallic portion of the gripper thus allowing mechanical lifting force to be passed from the patient handling equipment to the sheet.

7. The patient handling assembly of claim 1, wherein the ball, or similarly function piece of the invention is either removable, or not attached via a lanyard of any kind to the remainder of the patient handling assembly.
